(19) United States
(12) Patent Application Publication
(10) Pub. No.: US 2005/0229563 A1
(43) Pub. Date: Oct. 20, 2005

(54) Filter element

(76) Inventors: Mark V. Holzmann, Stoughton, WI (US); Robert A. Bannister, Stoughton, WI (US); Christopher E. Holm, Madison, WI (US); Michael J. Connor, Stoughton, WI (US); Larry T. Gunderson, Madison, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/827,509

(22) Filed: Apr. 19, 2004

(51) Int. Cl. B01D 46/00

(52) U.S. Cl. 55/502

(57) ABSTRACT

A filter element for mounting in a filter housing has a support frame for supporting filter media and a seal integrally formed with the support frame for sealing against the filter housing.

### BACKGROUND AND SU RY

The invention relates to filters, and more particularly the sealing system for sealing a filter element in a filter housing.

Fluid filters, including for liquid and gas, and especially those used in engine applications, separate contaminants from fluid streams, such as air, oil, fuel, and blow-by exhaust gases. To ensure that the filter protects the equipment receiving the noted fluids, a seal is provided between the filter element and a housing. Commonly, separate rubber seals are used to ensure that elastic contact is maintained with the filter housing during the life of the filter element A drawback of separate seals is that they can be lost, or mis-installed. Another drawback is the requirement of additional parts to design, manufacture, inventory, and assemble. The structure retaining such seals such as the end cap or support frame of the filter element must be rigid enough to contain the other components of the filter and resist forces and stresses during operation. In some cases, the seal must be adhered to the filter end cap, support frame, or some other component.

With increasing requirements in view of environmental regulations and the desire for a disposable filter element, there is a trend away from filter elements with metal components, in favor of plastic components which may be disposed of via incineration. Such plastic components used for support frames or end caps for filter elements typically use a separate seal component of a rubber compound, or are provided by a potted component, such as urethane, e.g. providing potted urethane end caps.

The present invention evolved during continuing development efforts to provide a filter element support frame or end cap having a seal integrally formed therewith for sealing against a filter housing and satisfying temperature and chemical resistive requirements without resorting to separate components such as rubber seals and without resorting to potting of urethane or the like.

### BRIEF DESCRIPTION OF THE DRAWING

FIG. 1 is a sectional perspective view of a filter element mounted and sealed in a filter housing in accordance with the invention.

FIG. 2 is an enlarged view of a portion of FIG. 1.

FIG. 3 is a side sectional view showing an alternate embodiment of a portion of FIG. 1.

FIG. 4 is like FIG. 3 and shows another embodiment.

FIG. 5 is like FIG. 3 and shows another embodiment.

FIG. 6 is like FIG. 3 and shows another embodiment.

FIG. 7 is like FIG. 3 and shows another embodiment.

FIG. 8 is like FIG. 3 and shows another embodiment.

FIG. 9 is an exploded perspective view taken from FIG. 1 of U.S. Pat. No. 6,568,540, incorporated herein by reference.

FIG. 10 is a side sectional view of a portion of FIG. 9 but illustrating a filter element support frame seal in accordance with the invention.

FIG. 11 is like FIG. 10 and shows another embodiment.

FIG. 12 is like FIG. 10 and shows another embodiment.

FIG. 13 is like FIG. 10 and shows another embodiment.

FIG. 14 is like FIG. 10 and shows another embodiment.

### DETAILED DESCRIPTION

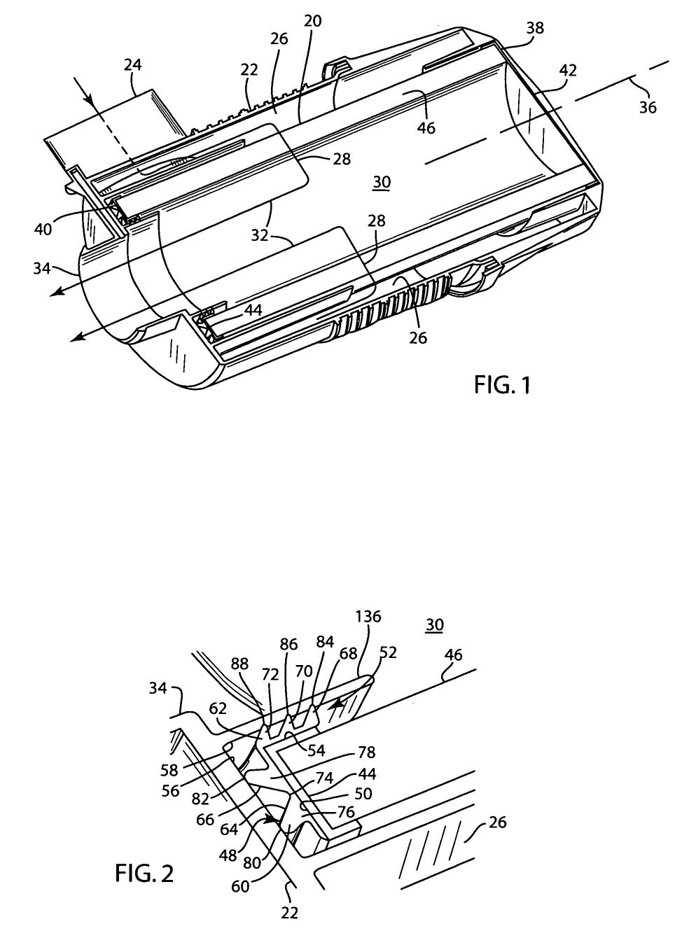

FIG. 1 shows a filter element 20 for mounting in a filter housing 22 having an inlet 24 receiving fluid to be filtered, such as air, which air passes into outer annular chamber 26 within the housing and then radially inwardly as shown at 28 through filter element 20 into hollow interior 30 as clean filtered air, and then exists axially as shown at 32 through outlet 34, all as is known. Filter element 20 is an annular filter element extending axially along an axis 36 between first and second axial ends 38 and 40, and having the noted hollow interior 30. Axial end 38 may have an end cap 42 spanning hollow interior 30 to seal clean air plenum 30 from dirty air plenum 26, or may be sealed to filter housing 22 similarly to filter end 40, to now be described. Filter end 40 has a support frame end cap 44, FIG. 2, supporting the filter media 46 of filter element 20, and having a seal 48 integrally formed therewith for sealing against filter housing 22 to isolate clean air plenum 30 from dirty air outer annular chamber plenum 26. Dirty air in plenum 26 must pass radially inwardly at 28 through filter media 46 of filter element 20, and not bypass the filter media by otherwise flowing around axial ends 38 or 40.

Seal 48 is softer than support frame end cap 44. Support frame end cap 44 is substantially rigid. Support frame 44 and seal 48 are of different materials, with the material of seal 48 being softer than the material of support frame 44, and with each of the materials being heat and chemical resistant, including the softer material of seal 48. In the preferred embodiment, in combination, support frame end cap 44 is an injection molded plastic member, and seal 48 is an injection molded thermoplastic member, and neither member is potted urethane. The seal is preferably TPE (thermoplastic elastomer), or TPV (thermoplastic vulcanite), or TPSiV (thermoplastic silicon vulcanite).

End cap 44 has an axially facing first annular surface 50 circumscribing an aperture 52 through such end cap which communicates with hollow interior 30. The end cap has a radially facing second-annular surface 54 circumscribing such aperture. Seal 48 extends along at least one and preferably both of such annular surfaces 50 and 54 and engages a portion of the filter housing, preferably at both housing portions 56 and 58 facing the respective annular surface. Seal 48 at segment 60 spans between annular surface 50 of the filter element support frame end cap 44 and filter housing portion 56. Seal 48 at segment 62 spans between annular surface 54 of support frame endcap 44 and portion 58 of the filter housing. It is further preferred that both of the first and second segments or portions 60 and 62 of seal 48 have one or more deflection fingers, such as deflection fingers 64, 66 along segment 60, and deflection fingers 68, 70, 72 along segment 62, deflectingly engaging a respective portion of the filter housing. At least one of the fingers such as 64, 66 is axially defected. At least another of the fingers such as 68, 70, 72 is radially deflected. Each deflected finger 64, 66, 68, 70, 72 forms an annular seal with the filter housing. For example, deflection fingers 64, 66 form annular seals with filter housing portion 56. Deflection fingers 68, 70, 72 form annular seals with filter housing portion 58.

Seal 48 extends at segment 60 along annular surface 50 of support frame end cap 44 and has a V-shape with the apex 74 of the V at axially facing first annular surface 50 of the end cap, and the legs 76 and 78 of the V diverging from the apex and engaging filter housing 22 at portion 56 at radially spaced engagement points 80 and 82 each defining an annulus circumscribing aperture 52. Seal 48 at segment 62 extends along radially facing second annular surface 54 of support frame end cap 44 and has a plurality of angled barbs provided by the noted deflection fingers 68, 70, 72 extending radially and axially from second-annular surface 54 and engaging portion 58 of filter housing 22 at axially spaced engagement points 84, 86, 88 each defining an annulus circumscribing aperture 52.

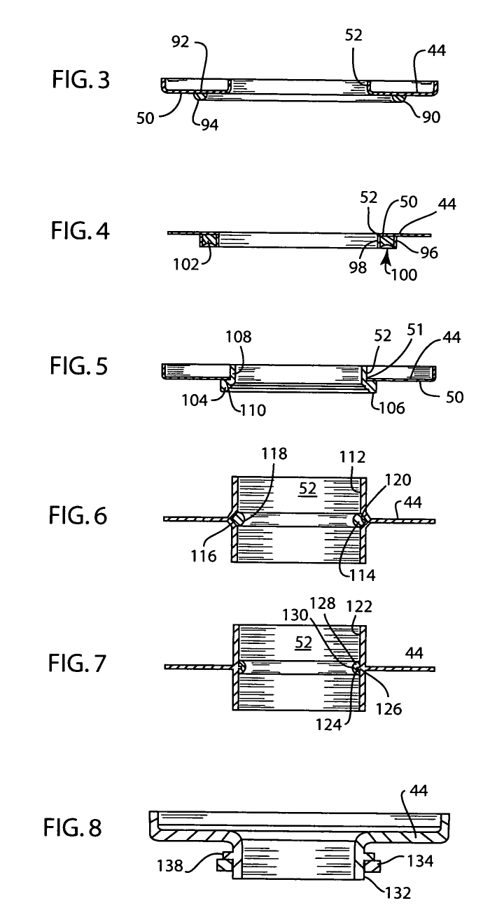

FIG. 3 shows support frame end cap 44 with alternate seal 90 integrally formed therewith. Seal 90 has a flat first surface 92 on axially facing annular surface 50 of end cap 44, and has an arcuate second surface 94 engaging filter housing 22 at axial surface 56 in sealing relation along an annulus circumscribing aperture 52. Seal 90 is semi-circular in radial cross-section.

FIG. 4 shows end cap 44 having axially facing annular surface 50 circumscribing aperture 52 and in an alternate embodiment having a pair of walls 96 and 98 extending axially from surface 50 and separated by a radial gap 100 therebetween, which gap defines an annular channel circumscribing aperture 52, wherein seal 102 is in the noted annular channel.

FIG. 5 shows end cap 44 having axially facing first annular surface 50 circumscribing aperture 52, and a radially facing second annular surface 51 circumscribing aperture 52. Seal 104 extends along both of the noted annular surfaces 50 and 51 of support frame end cap 44 and includes a first segment 106 engaging first portion 56 of filter housing 22 axially facing first annular surface 50 of end cap 44, and a second segment 108 engaging second portion 58 of filter housing 22 facing second annular surface 51 of support frame end cap 44. First segment 106 of seal 104 extends axially beyond first annular surface 50 of end cap 44 and is tapered radially outwardly at 110 from aperture 52 away from second segment 108 of seal 104.

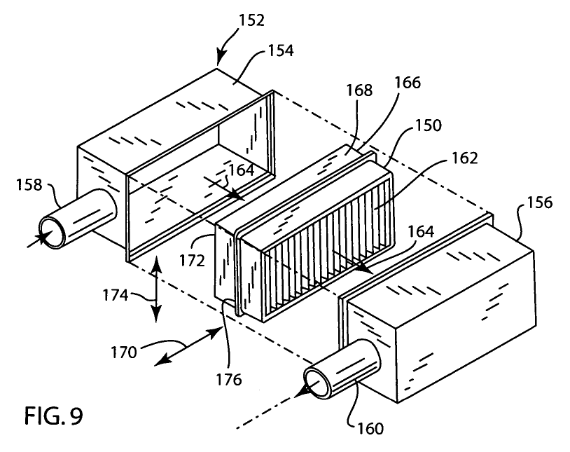

In FIG. 6, end cap 44 has a radially facing annular surface 112 circumscribing aperture 52, and seal 114 is on radially facing annular surface 112 and circumscribes aperture 52. Seal 114 has a first arcuate surface 116 on radially facing annular surface 112 of end cap 44, and has a second arcuate surface 118 engaging filter housing 22 at portion 58 along an annulus. Surface 112 faces radially inwardly and has a recessed annular groove 120 receiving arcuate surface 116 of seal 114 therein. In an alternate embodiment, FIG. 7, radially inwardly facing annular surface 122 of the end cap is provided with a protruding lip 124 receiving arcuate surface 126 of seal 128 thereon. Seal 128 has a C-shape with first and second generally parallel C-shaped surfaces 126 and 130. C-shaped surface 126 provides the noted first arcuate surface of the seal. C-shaped surface 130 provides the noted second arcuate surface of the seal. Arcuate surfaces 126 and 130 of the seal are generally parallel to each other. In a further embodiment, FIG. 8, radially facing annular surface 132 of end cap 44 faces radially outwardly. Seal 134 extends radially outwardly from radially outwardly facing annular surface 132 for engaging filter housing 22 at outlet 34 along radially inwardly facing surface 136, FIG. 2. Annular seal 134 is axially stopped against annular shoulder 138 on surface 132.

In FIGS. 9-14, the filter element is a panel filter element 150 mounted in a housing 152 having portion 154 and 156 having inlet 158 and outlet 160, respectively, and passing fluid such as air to be filtered through filter media 162 as shown at arrow 164, and for which further reference may be had to U.S. Pat. No. 6,568,540, incorporated herein by reference. Panel filter element 150 lies in a plane having a perimeter 166. Support frame 168 extends along the noted plane around perimeter 166 of panel filter element 150. The plane defines a lateral dimension 170. Support frame 168 has a sidewall 172 extending longitudinally along a height dimension 174 transverse to the noted plane and transverse to lateral dimension 170. Seal 176 is integrally formed on sidewall 172 of support frame 168 for sealing against filter housing 152, and is preferably integrally formed along the entire perimeter of panel filter element 150. Seal 176 extends laterally from sidewall 172, FIG. 10. Seal 176 in FIG. 10 has an eccentric shape in lateral cross-section.

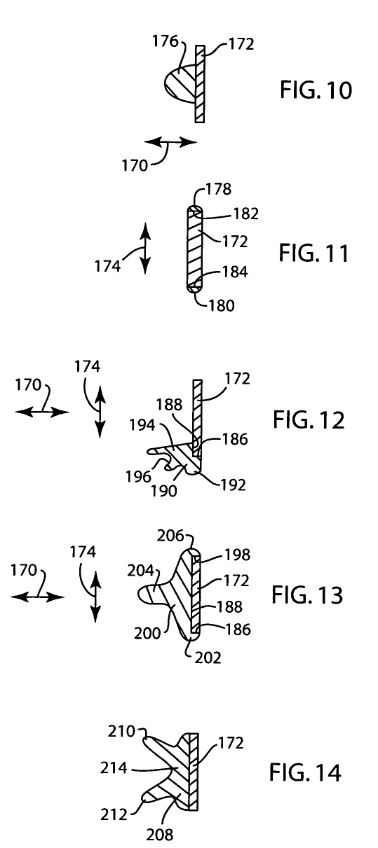

FIG. 11 shows an alternate embodiment wherein seals 178 and 180 extend longitudinally from sidewall 172. Sidewall 172 extends longitudinally between first and second distally spaced ends 182 and 184. The seal preferably comprises a first seal 178 on first end 182, and a second seal 180 on second end 184.

In FIG. 12, sidewall 172 has a first longitudinally facing surface 186, and a second laterally facing surface 188. Seal 190 extends along both of the noted first and second surfaces 186 and 188 of sidewall 172 at segments or portions 192 and 194, respectively, of the seal. Seal segment 194 extending along surface 188 of sidewall 172 has a chevron shape as shown at 196.

In FIG. 13, sidewall 172 has a first longitudinally facing surface 186, a second laterally facing surface 188, and a third longitudinally facing surface 198. Surfaces 186 and 198 are distally longitudinally spaced by surface 188 therebetween. Seal 200 extends along all three of the noted surfaces 186, 188, 198. Seal 200 extends along the entire longitudinal dimension 174 of sidewall 172 and has a first portion 202 extending longitudinally from first surface 186 of sidewall 172, a second portion 204 extending laterally from surface 188 of sidewall 172, and a third portion 206 extending longitudinally from surface 198 of sidewall 172.

In FIG. 14, seal 208 has a pair of deflection fingers 210 and 212 longitudinally spaced from each other and laterally deflectable for sealing against filter housing 152. Fingers 210 and 212 diverge from each other in a V-shape from an apex 214 at sidewall 172. Each finger extends obliquely relative to each of the noted longitudinal and lateral directions.

In accordance with the present invention, a method is provided for making a filter element for mounting in a filter housing, the filter element comprising filter media, and a support frame supporting the filter media. The method involves injection molding the support frame, and injection molding a seal onto the injection molded support frame to seal against the filter housing. In one embodiment, the method includes injection molding the support frame in a first mold, then removing the support frame from the first mold and placing the support frame in a second mold, then injection molding the seal onto the support frame in the second mold. In another embodiment, the method involves injection molding the support frame in a mold, then injection molding the seal onto the support frame in the same mold.

It is recognized that various equivalents, alternatives and modifications are possible within the scope of the appended claims.

1. A filter element for mounting in a filter housing, said filter element comprising filter media, and a support frame supporting said filter media, said support frame having a seal integrally formed therewith for sealing against said filter housing.

2. The filter element according to claim 1 wherein said seal is integrally molded with said support frame.

3. The filter element according to claim 1 wherein said seal is softer than said support frame.

4. The filter element according to claim 3 wherein said support frame is substantially rigid.

5. The filter element according to claim 1 wherein said support frame and said seal are of different materials.

6. The filter element according to claim 5 wherein the material of said seal is softer than the material of said support frame.

7. The filter element according to claim 6 wherein each of said materials is heat and chemical resistant, including the softer material of said seal.

8. The filter element according to claim 1 wherein in combination:
said support frame is an injection molded plastic member; and
said seal is an injection molded thermoplastic member,
neither said support nor said seal being potted.

9. The filter element according to claim 1 wherein said seal is TPE.

10. The filter element according to claim 1 wherein said seal is TPV.

11. The filter element according to claim 1 wherein said seal is TPSiV.

12. The filter element according to claim 3 wherein:
said filter element is an annular filter element extending axially along an axis between first and second axial ends, and having a hollow interior;
said support frame is an end cap at one of said axial ends, said end cap having an aperture therethrough communicating with said hollow interior;
said seal is integrally formed on said end cap for sealing against said filter housing.

13. The filter element according to claim 12 wherein:
said end cap has an axially facing first annular surface circumscribing said aperture, and a radially facing second annular surface circumscribing said aperture;
said seal extends along at least one of said first and second annular surfaces and engages a portion of said filter housing facing said one annular surface, with said seal spanning between said one annular surface and said portion of said filter housing.

14. The filter element according to claim 13 wherein said seal extends along both of said first and second annular surfaces of said end cap and comprises a first segment engaging a first portion of said filter housing axially facing said first annular surface of said end cap, and a second segment engaging a second portion of said filter housing radially facing said second annular surface of said end cap.

15. The filter element according to claim 14 wherein both of said first and second segments have one or more deflection fingers extending therefrom and deflectingly engaging a respective said portion of said filter housing, at least one of said fingers being axially deflected, and at least another of said fingers being radially deflected, each said deflection finger forming an annular seal with said filter housing.

16. The filter element according to claim 13 wherein said seal extends along said first annular surface of said end cap and has a V-shape with the apex of the V at said axially facing first annular surface of said end cap, and the legs of the V diverging from said apex and engaging said filter housing at radially spaced engagement points each defining an annulus circumscribing said aperture.

17. The filter element according to claim 13 wherein said seal extends along said radially facing second annular surface of said end cap and has a plurality of angled barbs extending radially and axially from said second annular surface and engaging said filter housing at axially spaced engagement points each defining an annulus circumscribing said aperture.

18. The filter element according to claim 13 wherein:
said seal extends along said axially facing first annular surface of said end cap and has a V-shape with the apex of the V at said axially facing first annular surface of said end cap, and the legs of the V diverging from said apex and engaging said filter housing at a first set of engagement points radially spaced from each other and defining a first set of annuli circumscribing said aperture;
said seal extends along said radially facing second annular surface of said end cap and has a plurality of angled barbs extending radially and axially from said radially facing second annular surface and engaging said filter housing at a second set of engagement points axially spaced from each other and defining a second set of annuli circumscribing said aperture.

19. The filter element according to claim 12 wherein said end cap has an axially facing annular surface circumscribing said aperture, and said seal is on said axially facing annular surface of said end cap.

20. The filter element according to claim 19 wherein said seal has a flat first surface on said axially facing annular surface of said end cap, and has an arcuate second surface engaging said filter housing in sealing relation along an annulus circumscribing said aperture.

21. The filter element according to claim 20 wherein said seal is semi-circular in radial cross-section.

22. The filter element according to claim 12 wherein said end cap has an axially facing annular surface circumscribing said aperture, and a pair of walls extending axially from said surface and separated by a radial gap therebetween, said gap defining an annular channel circumscribing said aperture, and wherein said seal is in said annular channel.

23. The filter element according to claim 12 wherein:
said end cap has an axially facing first annular surface circumscribing said aperture, and a radially facing second annular surface circumscribing said aperture;
said seal extends along both of said annular surfaces of said end cap and comprises a first segment engaging a first portion of said filter housing axially facing said first annular surface of said end cap, and a second segment engaging a second portion of said filter housing radially facing said second annular surface of said end cap;
said first segment of said seal extends axially beyond said first annular surface of said end cap and is tapered radially outwardly from said aperture away from said second segment of said seal.

24. The filter element according to claim 12 wherein said end cap has a radially facing annular surface circumscribing said aperture, and said seal is on said radially facing annular surface and circumscribes said aperture.

25. The filter element according to claim 24 wherein said seal has a first arcuate surface on said radially facing annular surface of said end cap, and has a second arcuate surface engaging said filter housing along an annulus.

26. The filter element according to claim 25 wherein said radially facing annular surface of said end cap is a recessed annular groove receiving said first arcuate surface of said seal therein.

27. The filter element according to claim 25 wherein said radially facing annular surface of said end cap is a protruding lip receiving said first arcuate surface of said seal thereon.

28. The filter element according to claim 27 wherein said seal has a C-shaped with first and second generally parallel C-shaped surfaces, said first C-shaped surface being said first arcuate surface of said seal, said second C-shaped surface being said second arcuate surface of said seal, said first and second arcuate surfaces of said seal being generally parallel to each other.

29. The filter element according to claim 24 wherein said radially facing annular surface of said end cap faces radially inwardly.

30. The filter element according to claim 24 wherein said radially facing annular surface of said end cap faces radially outwardly.

31. The filter element according to claim 30 wherein said seal extends radially outwardly from said radially outwardly facing annular surface of said end cap.

32. The filter element according to claim 3:
said filter element is a panel filter element lying in a plane and having a perimeter;
said support frame extends along said plane around said perimeter of said panel filter element, said plane defining a lateral dimension, said support frame having a sidewall extending longitudinally along a height dimension transverse to said plane and said lateral dimension;
said seal is integrally formed on said sidewall of said support frame for sealing against filter housing.

33. The filter element according to claim 32 wherein said seal extends laterally from said sidewall.

34. The filter element according to claim 33 wherein said seal has an eccentric shape in lateral cross-section.

35. The filter element according to claim 32 wherein said seal extends longitudinally from said sidewall.

36. The filter element according to claim 35 wherein said sidewall extends longitudinally between first and second distally spaced ends, and said seal comprises a first seal on said first end and a second seal on said second end.

37. The filter element according to claim 32 wherein said sidewall has a first longitudinally facing surface and a second laterally facing surface, and wherein said seal extends along both of said first and second surfaces of said sidewall.

38. The filter element according to claim 37 wherein said seal extending along said second surface of said sidewall has a chevron shape.

39. The filter element according to claim 32 wherein said sidewall has a first longitudinally facing surface, a second laterally facing surface, and a third longitudinally facing surface, said first and third surfaces being distally longitudinally spaced by said second surface therebetween, and wherein said seal extends along all three of said first, second and third surfaces.

40. The filter element according to claim 39 wherein said seal extends along the entire longitudinal dimension of said sidewall and has a first portion extending longitudinally from said first surface of said sidewall, a second portion extending laterally from said second surface of said sidewall, and a third portion extending longitudinally from said third surface of said sidewall.

41. The filter element according to claim 33 wherein said seal has a pair of deflection fingers longitudinally spaced from each other and laterally deflectable for sealing against said filter housing.

42. The filter element according to claim 41 wherein said fingers diverge from each other in a V-shape from an apex at said sidewall, each finger extending obliquely relative to each of said longitudinal and lateral directions.

43. A method for making a filter element for mounting in a filter housing, said filter element comprising filter media, and a support frame supporting said filter media, said method comprising injection molding said support frame, and injection molding a seal onto said injection molded support frame to seal against said filter housing.

44. The method according to claim 43 comprising injection molding said support frame in a first mold, then removing said support frame from said first mold and placing said support frame in a second mold, then injection molding said seal onto to said support frame in said second mold.

45. The method according to claim 43 comprising injection molding said support frame in a mold, then injection molding said seal onto said support frame in the same said mold.
